(19) United States
(12) Patent Application Publication
(10) Pub. No.: US 2017/0008739 A1
(43) Pub. Date: Jan. 12, 2017

(54) SYSTEM AND METHOD FOR LIFTING WITH SPREADER BAR

(71) Applicant: General Electric Company, Schenectady, NY (US)

(72) Inventors: Quoc Hoai Nguyen, League City, TX (US); Michael Anthony Acosta, Baytown, TX (US); Jordan Scott Warton, Pasadena, TX (US)

(21) Appl. No.: 14/794,697

(22) Filed: Jul. 8, 2015

(51) Int. Cl. B66C 13/18; B66C 15/06; B66C 13/16; B66C 1/10

(52) U.S. Cl. CPC B66C 13/18; B66C 1/10; B66C 15/06; B66C 13/16

(57) ABSTRACT

A system includes a spreader bar comprising a structural support, a first load coupling, and a second load coupling, and a lift coupling and a drive system coupled to the lift coupling. The system also includes at least one load sensor configured to sense a load coupled to the first load coupling, the second load coupling, or a combination thereof. A controller may be coupled to the drive system and the at least one load sensor, such that the controller is configured to obtain an indication of a center of gravity of the load based on the at least one load sensor, and the controller is configured to operate the drive system to move the lift coupling based on the center of gravity.

### BACKGROUND OF THE INVENTION

The subject matter disclosed herein relates to lifting of loads, such as heavy machinery.

A variety of industrial and commercial applications may use heavy machinery, such as reciprocating engines, electrical generators, and turbomachinery (e.g., turbines, compressors, and pumps). The heavy machinery may be moved for many reasons, such as initial installation, servicing, or replacement. Unfortunately, moving the heavy machinery may be difficult due to balancing problems during lifting.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a spreader bar comprising a structural support, a first load coupling, and a second load coupling, and a lift coupling and a drive system coupled to the lift coupling. The system also includes at least one load sensor configured to sense a load coupled to the first load coupling, the second load coupling, or a combination thereof. A controller may be coupled to the drive system and the at least one load sensor, such that the controller is configured to obtain an indication of a center of gravity of the load based on the at least one load sensor, and the controller is configured to operate the drive system to move the lift coupling based on the center of gravity.

In a second embodiment, a system includes a lift controller configured to couple to at least one load sensor and a drive system of a spreader bar, such that the lift controller is configured to obtain an indication of a center of gravity of a load coupled to the spreader bar based on load feedback from the at least one load sensor. The lift controller is also configured to operate the drive system to move a lift coupling based on the center of gravity.

In a third embodiment, a method includes obtaining feedback from at least one load sensor indicative of a load coupled to at least one of a first load coupling or a second load coupling of a spreader bar, such that the spreader bar comprises a structural support and a lift coupling. The method also includes obtaining an indication of a center of gravity of the load based on the feedback from the at least one load sensor, and controlling a drive system coupled to the lift coupling to move the lift coupling based on the center of gravity.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic side view of an embodiment of a lifting system having a lift machine coupled to a smart spreader bar having a lift positioning system;

FIG. 2 is a schematic side view of an embodiment of a smart spreader bar having a lift positioning system;

FIG. 3 is a schematic top view of an embodiment of a smart spreader bar having a lift positioning system;

FIG. 4 is a diagram of an embodiment of a center of gravity indicator taken within line 4-4 of FIGS. 2 and 3;

FIG. 5 is a diagram of an embodiment of a center of gravity indicator taken within line 4-4 of FIGS. 2 and 3;

FIG. 6 is a diagram of an embodiment of a manual actuator and a drive system coupled to a lift coupling of the smart spreader bar of FIGS. 1-3;

FIG. 7 is a diagram of an embodiment of a manual actuator and a drive system coupled to a lift coupling of the smart spreader bar of FIGS. 1-3;

FIG. 8 is a diagram of an embodiment of a manual actuator and a drive system coupled to a lift coupling of the smart spreader bar of FIGS. 1-3;

FIG. 9 is a diagram of an embodiment of a control system, a monitoring system, a remote unit, and a central management system of the lifting system of FIGS. 1-3.

FIG. 10 is a schematic diagram of an embodiment of the control system for controlling the lifting system of FIGS. 1-3;

FIG. 11 is a flow chart of an embodiment of a computer-implemented method for controlling start-up of the lifting system of FIGS. 1-3; and

FIG. 12 is a flow chart of an embodiment of a computer-implemented method for controlling the operation of the lifting system of FIGS. 1-3.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed toward lifting systems that facilitate automatic or semi-automatic balancing of a load, such as heavy machinery. For example, the disclosed embodiments include a smart spreader bar with a lift positioning system configured to identify a center of gravity of a load (e.g., heavy machinery) based on sensor feedback, such as load sensor feedback. The lift positioning system also includes various displays and indicators, such as center of gravity indicators, to visually display the center of gravity to help with balancing of the load. The heavy machinery may include a turbine, compressor, generator, reciprocating engine, or any combination thereof. The lift positioning system includes one or more manual actuators and drive systems (e.g., electric, hydraulic, pneumatic) configured to move a lift coupling of the smart spreader bar based on the determined center of gravity, thereby helping to quickly and efficiently balance the load.

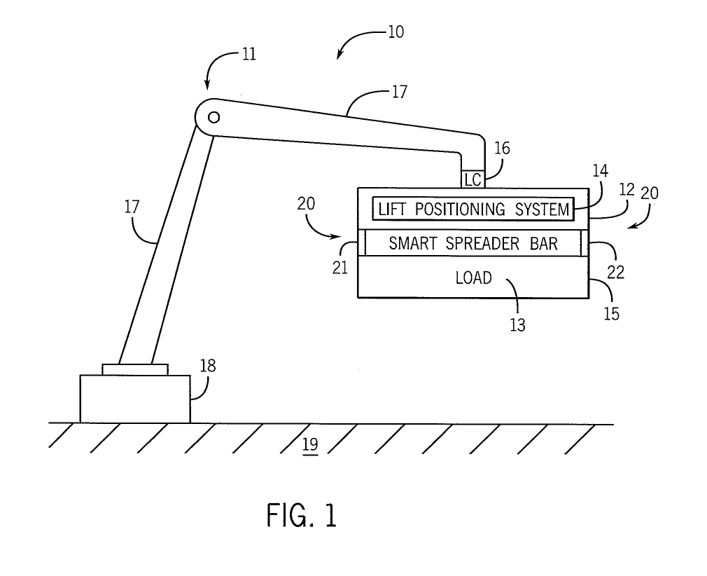

FIG. 1 is a schematic side view of an embodiment of a lifting system 10 having a lift machine 11 coupled to a smart spreader bar 12 having a lift positioning system 14. The lift machine 11 may include a gantry crane, a tower crane, a marine crane, a fork lift, or any other suitable lift machine. As discussed in detail below, the lift positioning system 14 of the smart spreader bar 12 may be configured to detect and indicate a center of gravity 13 of a load 15 coupled to the smart spreader bar 12, thereby helping to balance the load 15 relative to a lift coupling 16 between the smart spreader bar 12 and the lift machine 11. The lift coupling 16 may include a hook, a clasp, a lock, a clamp, a set of jaws, a holder, a chain, a cable, or any combination thereof, for coupling the lift positioning system 14 to the lift machine 11. The load 15 may include machinery, such as a reciprocating internal combustion engine, an electrical generator, and/or a turbomachine (e.g., a turbine, a compressor, a pump, etc.). For example, the load 15 may include a gas turbine engine having a compressor section, a combustor section, and a turbine section. The lift machine 11 may include one or more arms 17 coupled to a powered base 18, such as an engine-driven base. The powered base 18 may be configured to rotate or move along a platform 19. The platform 19 may be disposed on land or a vehicle, such as a truck, a trailer, or a ship. The powered base 18 may be coupled to a rotary mount and/or a rail mount on the platform 19. In certain embodiments, the powered base 18 may include wheels driven by the engine. The powered base 18 also may be configured to rotate, extend, retract, raise, and/or lower the one or more arms 17, thereby moving the smart spreader bar 12 and the coupled load 15. The smart spreader bar 12 couples to the load 15 via a plurality of load couplings 20 (e.g., first and second load couplings 21 and 22), while the spreader bar 12 couples to the arms 17 of the lift machine 11 via the lift coupling 16. In certain embodiments, the lift positioning system 14 senses loads at the first and/or second load couplings 20 and 21, calculates the center of gravity 13 based on the sensed loads, and then moves the lift coupling 16 along the smart spreader bar 12 to balance the load 15 based on the calculated center of gravity 13.

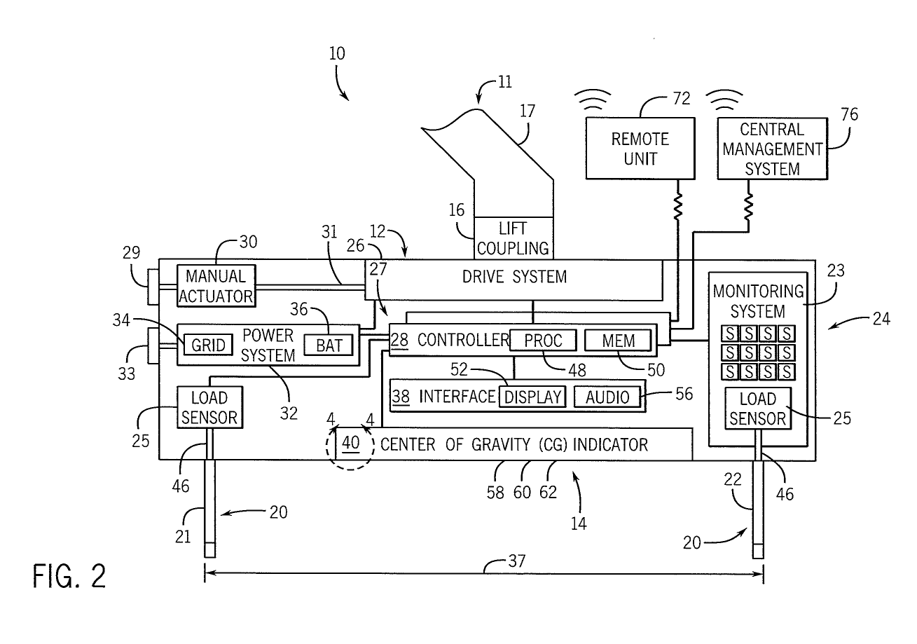

FIG. 2 is a schematic side view of an embodiment of a smart spreader bar 12, illustrating details of a lift positioning system 14. In the illustrated embodiment, the lift positioning system 14 includes a monitoring system 23 having a plurality of sensors 24 (e.g., load sensors 25), a drive system 26, a control system 27 having a controller 28, a manual actuator 30, and a power system 32. The monitoring system 23, the drive system 26, the control system 27, and the power system 32 are electrically and communicatively coupled together for power, data exchange, and control of the lift positioning system 14. As discussed in detail below, the lift positioning system 14 is configured to monitor sensor feedback from the sensors 24 (e.g., load sensors 25) via the monitoring system 23, calculate or estimate a center of gravity 13 of the load 15 based on the sensor feedback (e.g., load feedback), and then initiate movement of the spreader bar 12 relative to the lift coupling 16 and the arm 17 of the lift machine 11 to balance the load 15. For example, the control system 27 may control the drive system 26 and/or notify an operator to employ the manual actuator 30 to move the spreader bar 12 relative to the lift coupling 16 and the arm 17 of the lift machine 11 to balance the load 15. In either case, the drive system 26 and/or the manual actuator 30 may be configured to move the lift coupling 16 relative to the spreader bar 12, thereby moving the spreader bar 12 relative to the arms 17 of the lift machine 11.

The lift positioning system 14 is configured to use any combination of drives, such as the drive system 26 and/or the manual actuator 30. The manual actuator 30 may include a rotary actuator, a linear actuator, or a combination thereof. As illustrated, the manual actuator 30 includes an interface 29 and a shaft 31 coupled to the drive system 26. For example, the interface 29 may include a hand wheel, a crank shaft, a lever, a tool interface, or any combination thereof. The operator may push, pull, and/or turn the interface 29 to override or manually move the drive system 26, thereby adjusting the position of the lift coupling 16 relative to the spreader bar 12. In some embodiments, the manual actuator 30 may be used when the power system 32 lacks power, the drive system 26 is not functioning, and/or to fine tune the balancing of the load 15. The drive system 26 may include an electric drive, a hydraulic drive, a pneumatic drive, a transmission (e.g., worm drive, gearbox, planetary gear assembly, etc.), or any combination thereof. The power system 32 may include an electrical grid interface 33 coupled to a grid power supply 34, one or more batteries 36, solar panels, or other power supplies. The power supply 32 may power the electric drive (e.g., electric motor), an electric pump of the hydraulic drive, an electric compressor of the pneumatic drive, or any combination thereof. In operation, the controller 28 send a control signal to the drive system 26 and/or the power supply 32, thereby actuating the drive system 26 to move the lift coupling 16 a position within a threshold range based on (or relative to) the center of gravity 13. In some embodiments, acceptable limits of the threshold range about the center of gravity 13 may be plus or minus a deviation of between approximately 0 to 10 cm, 0 to 5 cm, 0 to 2 cm, 0 to 1 cm, 0 to 5 cm, while an overall length 37 of the spreader bar 12 may be between approximately 1 to 10 m, 2 to 7 m, or 3 to 5 m. In some embodiments, a ratio of the deviation/length 37 may be plus or minus approximately 0.0001, 0.001, or 0.01.

The controller 28 is configured to control the drive system 26 based on sensor feedback from the monitoring system 23, display information via an interface 38, and display information representing the center of gravity 13 via a center of gravity (CG) indicator 40. The sensors 24 may include one or more level sensors, angle sensors, tilt sensors, pitch sensors, roll sensors, accelerometers, wind sensors, temperature sensors, vibration sensors, seismic sensors, proximity sensors, among others to determine various conditions affecting the lift positioning system 14. For example, the sensors 24 may be configured to sense environmental conditions (e.g., wind), stability of the platform 19 (e.g., roll, pitch tilt, or acceleration) on a moving vehicle (e.g., moving or stationary ship in rough water), seismic activity to address areas prone to earthquakes, orientation of the spreader bar 12 (e.g., level, angle, tilt, pitch, roll, acceleration, etc.), and other parameters of the spreader bar 12. In some embodiments, the spreader bar 12 may include 1, 2, 3, 4, 5, 6, or more load sensors 25 coupled to the load 15 via the load couplings 20 (e.g., 21 and 22). For example, the load sensors 25 may be coupled to the load couplings 20 via load sensor connections 46. The load sensors 25 may include piezoelectric sensors, strain gauges, hydraulic pressure sensors, pneumatic sensors, fiber optic sensors, vibrating wire sensors, calibrated springs, or any other sensors suitable for measuring the weight of the load 15 and/or the torque at each of the load couplings 20, the lift coupling 16, or a combination thereof.

The monitoring system 23 and/or the control system 27 include inputs to receive the sensor feedback, wherein the controller 28 includes a processor 48 and memory 50 configured to process the sensor feedback and calculate the center of gravity 13. The controller 28 may include any number and type of processors 48, such as 1, 2, 3, or more redundant microprocessors. The memory 50 may include volatile memory, non-volatile memory, RAM, ROM, flash memory, or any combination thereof. The controller 28 utilizes the sensor feedback (e.g., sensor input from load sensors 25 and/or other sensors 24) to obtain (e.g., calculate, estimate, or lookup) a center of gravity 13 of the load 15. For example, the controller 28 may lookup a center of gravity 13 in a lookup table stored on the memory 50, calculate the center of gravity 13 via one or more equations stored on the memory 50, or obtain the center of gravity 13 via a computer model stored on the memory 50. Once the center of gravity 13 is obtained by the controller 28, the controller 28 may further account for other parameters, such as environmental conditions (e.g., wind), stability of the platform 19 (e.g., roll, pitch tilt, or acceleration) on a moving vehicle (e.g., moving or stationary ship in rough water), seismic activity to address areas prone to earthquakes, orientation of the spreader bar 12 (e.g., level, angle, tilt, pitch, roll, acceleration, etc.), or any combination thereof. For example, the controller 28 may use sensor feedback from the load sensors 25 (alone or in combination with the other sensors 24) to obtain an initial determination of the center of gravity 13, followed by adjustments based on sensor feedback from sensors 24, 25. The controller 28 may then determine a target position for the lift coupling 16, transmit a control signal from a controller output to the power system 32 and/or drive system 26, and move the lift coupling 16 to the target position to balance or substantially balance the load 15. Upon reaching or while moving to the target position, the lift positioning system 14 may use the manual actuator 30 and/or the drive system 26 to further fine tune the balancing of the load 15. For example, the monitoring system 23 may continuously monitor or periodically sample sensor feedback from the sensors 24, 25 and control the drive system 26 to move the lift coupling 16 to more accurately and efficiently balance the load 15 based on the center of gravity 13 and other parameters (e.g., wind, platform stability, etc.). Again, the manual actuator 30 also may be used to override the drive system 26 and/or fine tune the balancing of the load 15.

The monitoring system 23 and/or the control system 27 also may be coupled to a variety of output devices, such as the interface 38 and the CG indicator 40. The interface 38 may include a display 52 and an audio device 56. The display 52 may include a liquid crystal display (LCD), a touch screen, or any other suitable display device. The audio device 56 may include a speaker, a microphone, an alarm, a buzzer, or any other suitable audio device. The interface 38 (e.g., display 52 and audio device 56) may be configured to output visual and/or audio information relating to sensor feedback from the sensors 24, 25, calculations based on the sensor feedback (e.g., center of gravity 13), system information, environmental conditions, external parameters (e.g., seismic data), alerts and alarms, lifting procedures and specific steps, safety information and warnings, or any combination thereof. The interface 38 (e.g., display 52 and audio device 56) may be configured to output visual and/or audio information relating the spreader bar 12, the load 15, the lift machine 11, and the platform 19. For example, the interface 38 may output visual and/or audio information representing the weight of the load 15 and/or torque at the load couplings 20 and the lift coupling 16, the center of gravity 13 of the load 15, the orientation of the load 15 and/or spreader bar 12 (e.g., tilt, angle, pan, and roll), the speed and acceleration of the load 15 and/or spreader bar 12, and the position of the load 15 and/or spreader bar 12 relative to the platform 19, a target location, or surrounding equipment. By further example, the interface 38 may output visual and/or audio information representing specifications of the load 14 and/or spreader bar 12 (e.g., model number, serial number, service history, upgrades, dimensions, weight, previously recorded center of gravity if any, weight limit for the spreader bar 12, safety limits for environmental conditions such as wind, seismic, or platform stability, etc.). The interface 38 also may output visual and/or audio information representing the current location of the lifting point (e.g., lift coupling 16), error values, acceptable limits of the threshold range about the center of gravity 13, and so forth. The interface 38 also may output visual and/or audio information to alert the operator of system conditions that require additional precautions to be taken before lifting the load 15. For example, the interface 38 also may output visual and/or audio information to alert the operator of various messages, such as “do not lift,” “safe to lift,” “wait while system is calibrating,” “electrical problem detected—do not proceed,” “wind speed too high—do not proceed,” “platform unstable—do not proceed,” “weight of load exceed safety limit,” among other messages.

In some embodiments, the monitoring system 23 and/or the control system 27 is coupled to and provides signals to the CG indicator 40. The CG indicator 40 may include a visual indicator 58, such as an electronic indicator 60, a mechanical indicator 62, or a combination thereof. The electronic indicator 60 may include a liquid crystal display (LCD), a series of lights (e.g., LED lights, CFL lights, etc.) spaced apart from one another at discrete distances along all or part of the length 37, or any combination thereof, to indicate the center of gravity 13 and current position of the lift coupling 16. The mechanical indicator 62 may include a series of position indicia spaced apart from one another at discrete distances along all or part of the length 37, and one or more movable elements disposed along the series of position indicia to indicate the center of gravity 13 and current position of the lift coupling 16. The visual indicator 58 (e.g., electronic indicator 60 and mechanical indicator 62) also may indicate the acceptable limits of the threshold range about the center of gravity 13 along the spreader bar 12. As discussed in further detail below, the visual indicator 58 may indicate (e.g., illuminate, identify, point to) a first point representing the center of gravity 13, second and third points representing a range within acceptable limits of the center of gravity 13, a fourth point indicating the current position of the lift coupling 16 relative to the center of gravity 13, or any combination thereof. The lift positioning system 14 may include one or more CG indicators 40 extending between each set of load couplings 20 (e.g., 21 and 22), e.g., CG indicators 40 extending parallel and/or crosswise to one another on various sides of the spreader bar 12.

The monitoring system 23 and/or control system 27 (e.g., controller 28) may be communicatively coupled to a remote unit 72 and/or a central management system (CMS) 76. In some embodiments, the remote unit 72 and/or CMS 76 may be connected to systems 23, 27 through a wired or wireless connection (e.g., network or not-network connection), such as an internet or intranet connection, radio frequency (RF) communications, Bluetooth, or an industrial communications system. The remote unit 72 may be a remote monitoring unit, a remote control unit, or a combination thereof. The remote unit 72 may include a hand held computer (e.g., a tablet computer, a smart cell phone), a portable computer (e.g., a laptop computer), a stationary computer (e.g., a personal computer, a server, etc.), an industrial monitoring and/or control unit (or room), or any combination thereof. The CMS 76 may include a computer (e.g., one or more servers), an industrial monitoring and/or control unit (or room), or any combination thereof.

The remote unit 72 and/or CMS 76 may store, transmit, receive, and display data pertaining to the load 15, the spreader bar 12, the lift machine 11, a lifting procedure, or any combination thereof. For example, the remote unit 72 and/or CMS 76 may store, transmit, receive, and display data representing the weight of the load 15, the center of gravity 13, current location of the lifting point, error values, acceptable limits of the threshold range about the center of gravity, weather conditions or forecasts (e.g., wind conditions, temperature conditions, ocean conditions, storm conditions, etc.), and so forth. By further example, the remote unit 72 and/or CMS 76 may store, transmit, receive, and display data pertaining to a model number, a part number, a serial number, specifications, dimensions, safety limits (e.g., maximum load for spreader bar 12, maximum wind speed, etc.), historical service data, historical operating data, or any combination thereof, of the load 15, the spreader bar 12, and the lift machine 11. The remote unit 72 and/or CMS 76 may store, transmit, receive, and display data pertaining to trends or changes in certain conditions (e.g., weather, ocean conditions, stability of platform 19, etc.), fleet data (e.g., data of similar loads 15 in a fleet, such as a fleet of gas turbine engines), previous lifting operations, historical problems and solutions in lifting procedures, trial and error data, audio data, video data, alerts and alarms, and user input. In certain embodiments, the CMS 76 may record all data pertaining to a particular lifting procedure, and maintain a historical database of all lifting procedures. Therefore, the CMS 76 may record all sensor feedback from sensors 24, including feedback from load sensors 25, level sensors, angle sensors, tilt sensors, pitch sensors, roll sensors, accelerometers, wind sensors, temperature sensors, vibration sensors, seismic sensors, and proximity sensors, among others to determine various conditions affecting the lift positioning system 14.

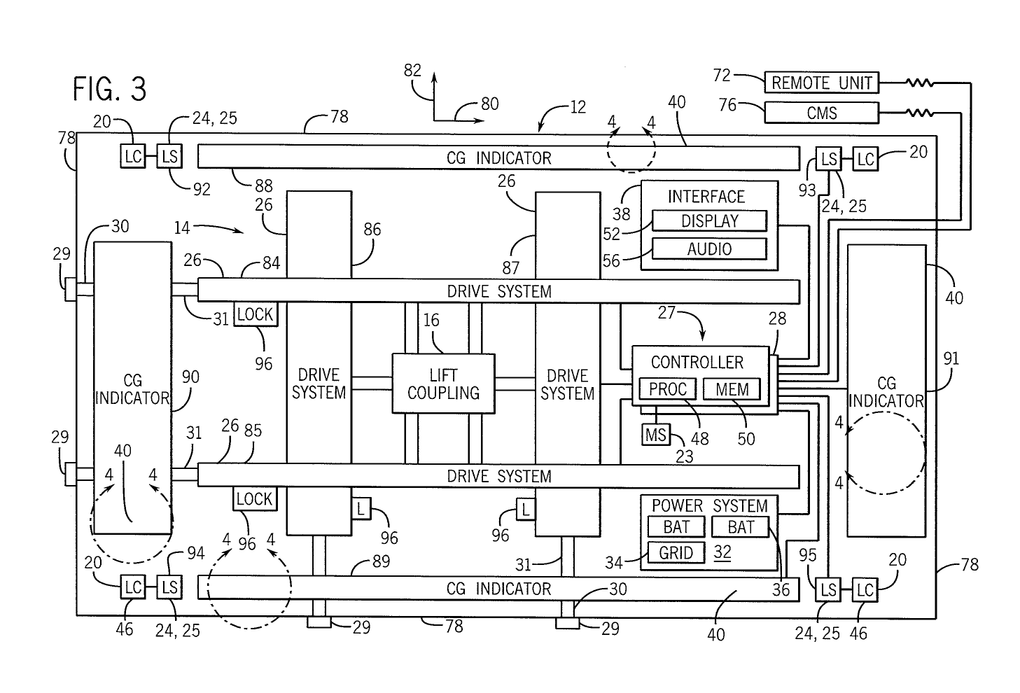

FIG. 3 is a schematic top view of an embodiment of a smart spreader bar 12 having a lift positioning system 14. In general, all features discussed above with reference to FIG. 2 apply to the embodiment of FIG. 3, and like elements are shown with like element numbers. In the illustrated embodiment, the spreader bar 12 includes structural supports or bars 78 extending in crosswise directions, e.g., along an X-axis or direction 80 and a Y-axis or direction 82. The lift positioning system 14 includes a plurality of drive systems 26 (e.g., first and second drive systems 84 and 85) extending in the direction 80 (e.g., parallel to one another) and a plurality of drive systems 26 (e.g., third and fourth drive systems 86 and 87) extending in the direction 82 (e.g., parallel to one another and perpendicular to direction 80). The lift positioning system 14 includes a plurality of CG indicators 40 (e.g., first and second CG indicators 88 and 89) extending in the direction 80 (e.g., parallel to one another) and a plurality of CG indicators 40 (e.g., third and fourth CG indicators 90 and 91) extending in the direction 82 (e.g., parallel to one another and perpendicular to direction 80). The lift positioning system 14 also includes a plurality of load couplings 20 (e.g., first, second, third, and fourth load couplings 20) and a plurality of load sensors 24, 25 (e.g., first, second, third, and fourth load sensors 92, 93, 94, and 95) in the four corner portions of the spreader bar 12. In the illustrated embodiment, the lift positioning system 14 includes a single lift coupling 16, although any number of lift couplings 16 (e.g., 1, 2, 3, 4, 5, 6, 7, 8, 9, 10, or more lift couplings 16) may be included with the spreader bar 12. The lift positioning system 14 also includes one or more monitoring systems 23, one or more control systems 27, one or more power systems 32, and one or more interfaces 38 coupled together and coupled to the various drive systems 26, CG indicators 40, load sensors 25, and other components.

In the illustrated embodiment, the drive systems 84 and 85 are configured to operate alone or in combination with one another to move the lift coupling 16 in the X-direction 80, while the drive systems 86 and 87 are configured to operate alone or in combination with one another to move the lift coupling 16 in the Y-direction 82. For example, each pair of drive systems 26 (e.g., drive systems 84 and 85 and drive systems 86 and 87) may be redundant or selectively used alone or in combination with one another depending on the weight of the load, weather conditions, stability of the platform 19, and other sensor feedback. Each pair of drive systems 26 is disposed in a parallel arrangement at an offset distance, and may help to stabilize movement of the lift coupling 16 and load 15 in the directions 80 and 82. In certain embodiments, the control system 27 may selectively operate the drive systems 26 alone or in combination with one another to balance the load 15 coupled to the spreader bar 12 relative to the lift coupling 16 and arm 17 of the lift machine 11. Similar to the embodiment of FIG. 2, each of the drive systems 26 (e.g., 84, 85, 86, and 87) may be coupled to or include a manual actuator 30 with an interface 29 to enable override of the drive system 26.

The monitoring system 23 may collect sensor feedback from the load sensors 25 (e.g., 92, 93, 94, and 95) and provide the sensor feedback to the control system 27 (e.g., controller 28) to calculate the center of gravity 13. In the illustrated embodiment, each of the CG indicators 40 (e.g., 88, 89, 90, and 91) may simultaneously indicate the center of gravity 13 on the four sides of the spreader bar 12, while also indicating a current position of the lift coupling 16. The controller 28 may then independently or cooperatively control the drive systems 26 (e.g., 84, 85, 86, and 87) to move the lift coupling 16 toward the center of gravity 13 (or within an acceptable range) as indicated by the CG indicators 40 (e.g., 88, 89, 90, and 91) on the four sides of the spreader bar 12. For example, depending on the location of the center of gravity 13, the controller 28 may adjust each drive system 26 (e.g., 84, 85, 86, and 87) to an equal, greater, or lesser extent. For example, the drive system 84 and/or manual actuator 30 may be used to adjust the position of the lift coupling 16 versus the center of gravity 13 as indicated by the CG indicator 40, 88, which may be based on sensor feedback from the load sensors 92 and 93 alone or in combination with the load sensors 94 and 95. The drive system 85 and/or manual actuator 30 may be used to adjust the position of the lift coupling 16 versus the center of gravity 13 as indicated by the CG indicator 40, 89, which may be based on sensor feedback from the load sensors 94 and 95 alone or in combination with the load sensors 92 and 93. The drive system 86 and/or manual actuator 30 may be used to adjust the position of the lift coupling 16 versus the center of gravity 13 as indicated by the CG indicator 40, 90, which may be based on sensor feedback from the load sensors 92 and 94 alone or in combination with the load sensors 93 and 95. The drive system 87 and/or manual actuator 30 may be used to adjust the position of the lift coupling 16 versus the center of gravity 13 as indicated by the CG indicator 40, 91, which may be based on sensor feedback from the load sensors 93 and 95 alone or in combination with the load sensors 92 and 94. In certain embodiments, the plurality of CG indicators 40 (e.g., 88, 89, 90, and 91) may be used for redundancy, viewing on all four sides, improved accuracy by enabling multiple checks of the center of gravity 13, or any combination thereof.

As further illustrated in FIG. 3, the lift positioning system 14 may include one or more locks 96 (e.g., position locks) associated with each of the plurality of drive systems 26 (e.g., 84, 85, 86, and 87). The locks 96 may be manual and/or automated locks, which may be coupled to and controllable by the control system 27. For example, once the drive systems 26 adequately balance the load 15 based on the center of gravity 13, the control system 27 may selectively engage the locks 96 to block movement of the drive systems 26 and the lift coupling 16. The locks 96 may include electric motor-driven locks, hydraulic-driven locks, pneumatic-driven locks, spring-loaded locks, or any combination thereof.

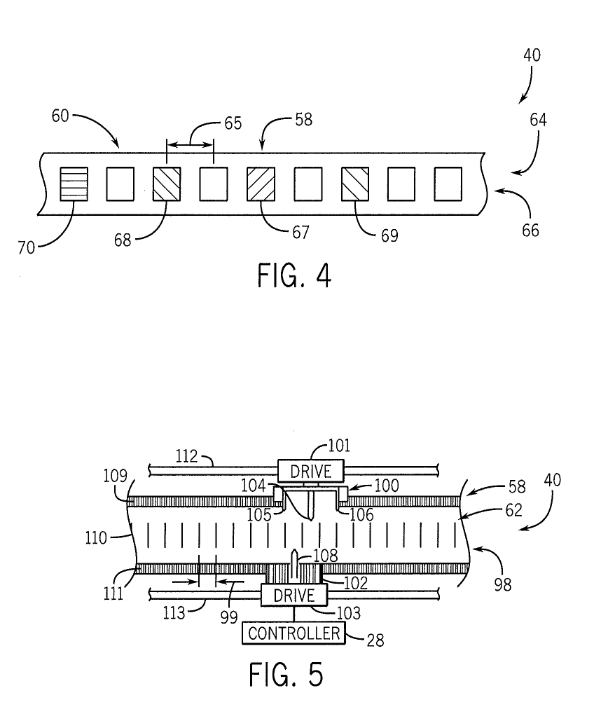

FIG. 4 is a diagram of an embodiment of the CG indicator 40 within lines 4-4 of FIGS. 2 and 3. In the illustrated embodiment, the CG indicator 40 has the visual indicator 58 with the electronic indicator 60 including a plurality of electronic visual indicia 64. In certain embodiments, the visual indicia 64 may be arranged in a series in the direction 80 or 82, and may be arranged with a spacing 65. The spacing 65 may be a uniform spacing ranging between approximately 1 mm to 5 cm, such as a spacing 65 of 1, 2, 3, 4, 5, 6, 7, 8, 9, or 10 mm, 1.5 cm, 2 cm, 2.5 cm, 3 cm, 4 cm, or 5 cm. The visual indicia 64 may be disposed in an electronic display (e.g., LCD display) or the visual indicia 64 may be discrete elements, such as lights 66. The lights 66 may include light emitting diodes (LEDs), incandescent bulbs, fluorescent bulbs, or any combination thereof. In certain embodiments, the controller 28 may actuate (e.g., power or illuminate) a first visual indicia 64, 67 (e.g., light 68) to indicate the center of gravity 13, a pair of second and third visual indicia 64, 68, 69 (e.g., light 68) to indicate a threshold range about the center of gravity 13, and a fourth visual indicia 64, 70 (e.g., light 68) to indicate a current position of the lift coupling 16 relative to the center of gravity 13. The controller 28 may actuate (e.g., power or illuminate) the visual indicia 64 (e.g., 67, 68, 69, and 70) with a variety of features (e.g., lights 66 of different colors (e.g., red, green, blue), steady lights, flashing lights, different rates or frequency of flashing, different intensities of the lights, or any combination thereof) to distinguish between the center of gravity 13, the threshold range about the center of gravity 13, and the current position of the lift coupling 16. In some embodiments, the controller 28 may actuate (e.g., power or illuminate) one light 66 to indicate the center of gravity 13, or a range of lights 66 to indicate an acceptable range about the center of gravity 13.

As will be appreciated, the controller 28 may actuate (e.g., power or illuminate) the lights 66 in a variety of colors. For example, a red light 70 may indicate that the current position of the lift coupling 16 along the drive system 26 is outside the acceptable range of the center of gravity 13. A yellow light 70 may indicate that the current position of the lift coupling 16 along the drive system 26 is within the acceptable range of the center of gravity 13 (e.g., at or between indicia 68 and 69). A green light 70 may indicate that the current position of the lift coupling 16 along the drive system 26 is directly at the center of gravity 13, e.g., directly at indicia 67. The controller 28 may be configured to vary the intensity, frequency and/or color of each light 66. In some embodiments, the intensity of the lights 66 may be adjusted to achieve less energy usage. For example, the lights 66 may be dimmed in some settings when the load 15 is being lifted during daylight. In some embodiments, the lights 66 may flash or blink (e.g., at a first rate) when the system is calibrating or the center of gravity 13 is being determined by the controller 28. The lights may also flash or blink (e.g., at a different second rate) to alert the user that the lights 66 are approaching the end of their useful life span. As will be appreciated, the user may configure the controller 28 to change the color of the lights 66, the intensity of the lights, what flashing or blinking lights indicate, and so forth.

FIG. 5 is a diagram of an embodiment of the CG indicator 40 within lines 4-4 of FIGS. 2 and 3. In the illustrated embodiment, the CG indicator 40 has the visual indicator 58 with the mechanical indicator 62 including a plurality of mechanical visual indicia 98. In certain embodiments, the visual indicia 98 may be arranged in a series in the direction 80 or 82, and may be arranged with a spacing 99 (e.g., a ruler, measuring stick, etc.). The spacing 99 may be a uniform spacing ranging between approximately 1 mm to 5 cm, such as a spacing 99 of 1, 2, 3, 4, 5, 6, 7, 8, 9, or 10 mm, 1.5 cm, 2 cm, 2.5 cm, 3 cm, 4 cm, or 5 cm. The visual indicia 98 may include mechanical marks (e.g., protrusions or recesses), colored marks (e.g., black, red, orange, etc.), or any combination thereof. The CG indicator 40 also includes a first movable location unit 100 coupled to a first drive 101, and a second movable location unit 102 coupled to a second drive 103. The first and second drives 101 and 103 are coupled to the controller 28 of the control system 27. The first and second drives 101 and 103 may include electronic motors, hydraulic drives, pneumatic drives, and/or mechanical actuators. The first movable location unit 100 may include a first pointer 104 configured to identify a position of the center of gravity 13 along the CG indicator 40 (e.g., mechanical indicator 62), and second and third pointers 105 and 106 to identify a threshold range about the center of gravity 13 along the CG indicator 40 (e.g., mechanical indicator 62). The second movable location unit 102 may include a fourth pointer 108 configured to identify a current position of the lift coupling 16 along the CG indicator 40 (e.g., mechanical indicator 62).

In the illustrated embodiment, the first movable location unit 100 may be coupled to and move along a first rail 109 of a panel 110 having the CG indicator 40, while the second movable location unit 102 may be coupled to and move along a second rail 111 of the panel 110 having the CG indicator 40. In addition, the first drive 101 may be coupled to and move along a first drive guide 112, while the second drive 103 may be coupled to and move along a second drive guide 113. The drive guides 112 and 113 may be threaded shafts, geared bars or racks, rails, or any combination thereof. In certain embodiments, the first and second drive guides 112 and 113 may be separate from, removably couple to, fixedly coupled to, or integrally formed as one-piece with the first and second rails 109 and 111.

In operation, the controller 28 may operate the drive 101 to move the first movable location unit 100 along the first rail 109 until the pointers 104, 105, and 106 are in an appropriate position to indicate the center of gravity 13 and the threshold range based on a calculation of the center of gravity 13 (e.g., using sensor feedback). The controller 28 also may operate the drive 103 to move the second movable location unit 102 along the second rail 111 until the pointer 108 is in an appropriate position to indicate the current position of the lift coupling 16, wherein the pointer 108 may be moved in real-time with concurrent movement of the lift coupling 16 by the drive system(s) 26. In certain embodiments, the drive system 26 includes the drive 103 and/or the drive system 26 couples to the second movable location unit 102 having the fourth pointer 108.

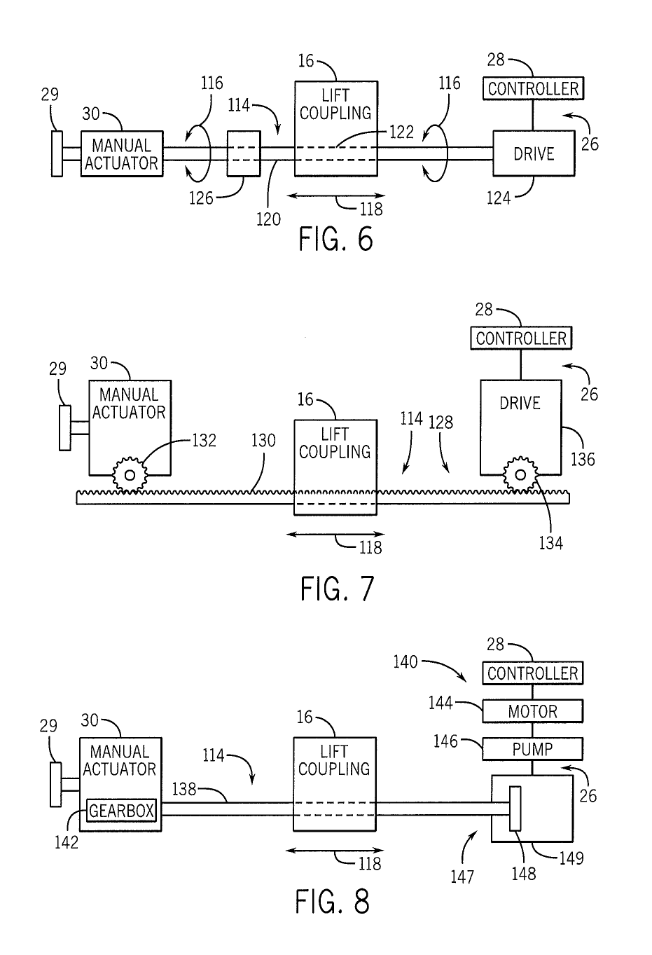

FIGS. 6, 7, and 8 are diagrams of embodiments of a manual actuator 30 and a drive system 26 coupled to a lift coupling 16 of the smart spreader bar 12 of FIGS. 1-3. In each embodiment, the drive system 26 and the manual actuator 30 are configured to selectively move the lift coupling 16 via movement (e.g., rotational direction 116 and/or axial direction 118) of a positional adjuster or transmission 114. The transmission 114 may include a track, a guide, a rod, a threaded shaft, a gear, a geared structure, a rack and pinion assembly, a worm and worm gear assembly, a chain, a cable, or any combination thereof. The manual actuator 30 includes the interface 29, which may include a hand wheel, a crank shaft, a lever, a tool interface, or any combination thereof. The manual actuator 30 may transfer rotational or linear motion from the interface 29 to rotational motion, axial motion, or a combination thereof, at the transmission 114. Similarly, the drive system 26 may create rotational or linear motion, which may be used to drive the transmission 114 via rotational motion, axial motion, or a combination thereof. The drive system 26 may include a hydraulic drive, an electric motor, a pneumatic drive, or any combination thereof.

In the embodiment of FIG. 6, the drive system 26 and the manual actuator 30 are configured to selectively rotate the transmission 114 in a circumferential or rotational direction 116, thereby causing movement of the lift coupling 16 in an axial direction 118. For example, the transmission 114 may include a threaded shaft 120, which threads into mating threads 122 (e.g., threaded receptacle or bore) in the lift coupling 16. In certain embodiments, the transmission 114 may include a worm and worm gear assembly. As the threaded shaft 120 rotates in the threads 122, the transmission 114 causes axial movement of the lift coupling 116. The manual actuator 30 may transfer rotational motion from the interface 29 (e.g., wheel or rotational tool interface) to the threaded shaft 120. Likewise, the drive system 26 may include a drive 124 (e.g., a rotational drive such as an electric motor) configured to transfer rotational motion to the threaded shaft 120. The drive system 26 also may include a plurality of bearings 126 disposed about the threaded shaft 120, e.g., in non-threaded portions of the shaft 120.

In the embodiment of FIG. 7, the drive system 26 and the manual actuator 30 are configured to selectively translate the transmission 114 in the axial direction 118, thereby causing movement of the lift coupling 16 in the axial direction 118. For example, the transmission 114 may include a rack and pinion assembly 128, which includes a linear gear or rack 130, a first circular gear or pinion 132 coupled to the manual actuator 30, and a second circular gear or pinion 134 coupled to a drive 136 of the drive system 26. The drive 136 may include an electric motor, a hydraulic drive, a pneumatic drive, or any combination thereof. As the manual actuator 30 transfers motion (e.g., rotational motion) from the interface 29 to the pinion 132, the pinion 132 causes movement of the rack 130 in the axial direction 118, thereby causing movement of the lift coupling 16 in the axial direction 118. Likewise, as the drive 136 rotates the pinion 134, the pinion 134 causes movement of the rack 130 in the axial direction 118, thereby causing movement of the lift coupling 16 in the axial direction 118.

In the embodiment of FIG. 8, the drive system 26 and the manual actuator 30 are configured to selectively translate the transmission 114 in the axial direction 118, thereby causing movement of the lift coupling 16 in the axial direction 118. For example, the transmission 114 may include a linearly movable shaft 138, which couples to the manual actuator 30 and a fluid drive 140 of the drive system 26. The manual actuator 30 may include a gearbox 142 configured to help convert a rotational input (e.g., angular displacement, torque, etc.) via the interface 29 to a suitable rotational output (e.g., angular displacement, torque, etc.) to the shaft 138. In certain embodiments, the gearbox 142 may include a plurality of settings to enable varying degrees of axial displacement of the shaft 138 for a given input of angular displacement via the interface 29 of the manual actuator 30. The fluid drive 140 may include a motor 144 coupled to the controller 28, a pump 146 driven by the motor 144, and a piston-cylinder assembly 147 fluidly coupled to the pump 146. The piston-cylinder assembly 147 may include a piston 148 disposed in a cylinder 149, wherein the piston 148 is further coupled to the shaft 138. In operation, the controller 28 may control the motor 144 to drive the pump 146, which in turn pumps a fluid (e.g., liquid or gas) into the cylinder 149 of the piston-cylinder assembly 147. The fluid then drives the piston 148 to move in the axial direction 118, thereby driving the lift coupling 16 to move in the axial direction 118. The controller 28 may be configured to vary the speed of the motor 144 and pump 146, thereby varying the speed of movement of the piston 148 and lift coupling 16. For example, the controller 28 may operate the fluid drive 140 at a first speed during a first stage of movement, a second speed during a second stage of movement, and a third speed during a third stage of movement, wherein the first, second, and third speeds are progressively less than one another.

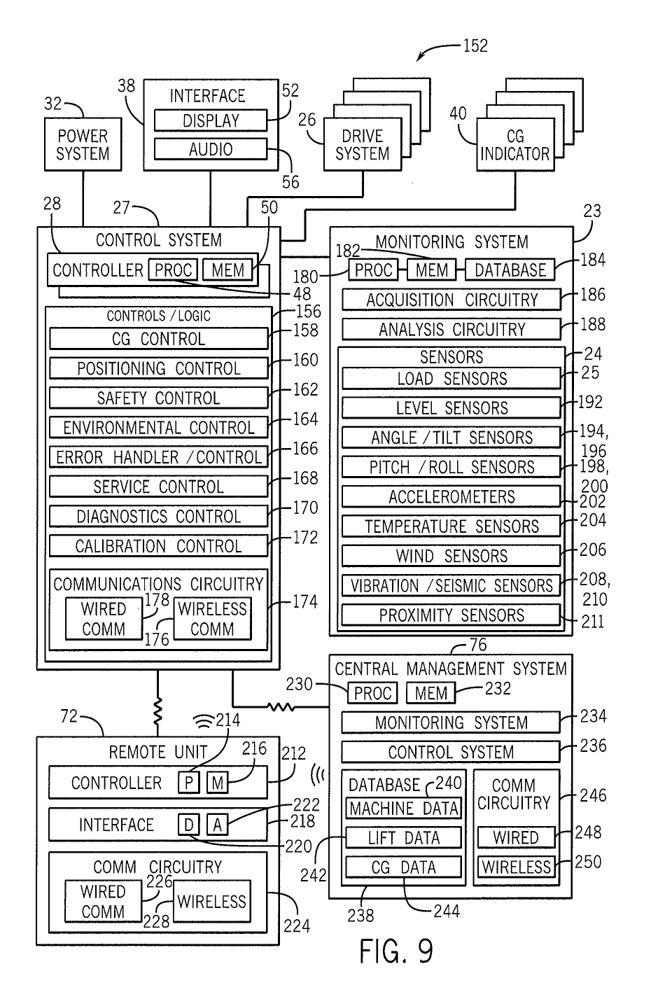

FIG. 9 is a diagram of an embodiment of a control system 27, a monitoring system 23, a remote unit 72, and a CMS 76 of the lifting system 10 of FIGS. 1-3. In certain embodiments, the control system 27 may utilize 1, 2, 3, 4, 5, or more controller 28 (e.g., single common controller, redundant controllers, independent controllers, etc). Similarly, the controllers 28 may include 1, 2, 3, or more processors 48 and memory 50. The control system 27 may be coupled to one or more of the power system 32, the interface 38, the drive systems 26, the CG indicator 40, and the monitoring system 23. Additionally, the control system unit 27 may be coupled to the remote unit 72 and the CMS 76 in some embodiments.

The controller 28 utilizes code or instructions that may be stored in any suitable article of manufacture that includes at least one tangible non-transitory, machine readable medium, such as the memory 50 of the controller 22. The processor circuitry 48 executes the code or instructions encoded in the memory 50 to calculate appropriate positions of the center of gravity 13 (e.g., CG control 158) and other controls logic 156. Utilizing the center of gravity control 158 enables the user to avoid manually determining the center of gravity, thereby eliminating timely trial and error methods. In some embodiments, the memory 48 may include code or instructions programmed to determine (e.g., calculate) data pertaining to a positioning control 160, safety control 162, environmental control 164, error handler/control 166, service control 168, diagnostics control 170, calibration control 172, and so forth. The control/logic 156 may be utilized to take several possible actions in the lift positioning system 14. For example, the positioning control 160 may utilize instructions coded in the memory 50 to move the lift coupling 16 to the appropriate position (e.g., center of gravity 13, or acceptable range of limits) along the drive system 26.

In some embodiments, the safety control 162 may utilize instructions coded in the memory 50 to output alerts, alarms, and control actions (e.g., stop operation) if certain conditions are detected by the sensors 24. For example, the safety control 162 may include thresholds for stability of platform 19, weight limits for the bar 12, safety procedures or steps, temperature thresholds for motors in the drive system 26, or other safety measures.

In some embodiments, the environmental control 164 may utilize instructions coded in the memory 50 to alert the user of the environmental conditions, changes in environmental conditions affecting the lift operation, and so forth. For example, the environmental control 164 may include thresholds for weather conditions (e.g., wind speed, seismic data, weather forecasts, ocean roughness affecting stability of platform 19, etc.). For example, the environmental control 164 may alert the user when an environmental condition (e.g., wind speed) exceeds a predetermined limit (e.g., wind speed not to exceed 30 m.p.h.) to operate the lift positioning system 14.

In some embodiments, the error handler/control 166 may utilize instructions coded in the memory 50 to correct error signals received from various sensors 24 disposed within the monitoring system 23. For example, the error handler/control 166 may monitor and provide warnings associated with malfunctions in the equipment, e.g., drive system 26, sensors 24, power system 32, and CG indicator 40.

In some embodiments, the service control 168 may alert the user or operator when the lift positioning system 14 needs to be serviced based on sensor feedback, service schedules, error data from the error handler/control 166, and/or diagnostic data from the diagnostic control 170. For example, the service control 168 may indicate to the operator that one or more of the lights 66 disposed in the CG indicator 40 needs to be replaced, indicate the need for replacement of sensors 24, and so forth.

In some embodiments, the diagnostics control 170 may utilize instructions coded in the memory 50 to diagnose components in the lift positioning system 14, and provide an alert, alarm, or action in response to any detected problems. For example, the diagnostics control 168 may alert the user that components of the drive system 26, the sensors 24, the power system 32, or the CG indicator 40 are experiencing problems (e.g., out of calibration, out of specifications, not responsive to controls, etc.). In some embodiments, the calibration control 172 may utilize instructions coded in the memory 50 to calibrate equipment of the lift positioning system 14, such as the drive system 26, the sensors 24, the power system 32, or the CG indicator 40. The control system 27 also may include communications circuitry 174 (e.g., wireless communications circuitry 176 and wired communications circuitry 178) to communicate with other components of the system 10.

As described above, the monitoring system 23 may be communicatively coupled to the control system 27. The monitoring system 23 may include a processor 48 and a memory 50. The monitoring system 23 utilizes a database 184 to record sensor feedback received from the sensors 24, calibration data for the sensors 24, monitoring schedules, and/or monitoring procedures. Acquisition circuitry 186 and analysis circuitry 188 are utilized in the monitoring system 23. Various sensor 24 signals are acquired and utilized in the monitoring system 23 via the acquisition circuitry 186. For example, the sensors 24 which send signals to the acquisition circuitry 186 may include one or more load sensors 25, level sensors 192, angle sensors 194, tilt sensors 196, pitch sensors 198, roll sensors 200, accelerometers 202, temperature sensors 204, wind sensors 206, vibration sensors 208, seismic sensors 210, and/or proximity sensors 211, among others to determine various conditions affecting the lift positioning system 14.

The remote unit 72 may include a controller 212, a processor 214, and a memory 216. The remote unit 72 may further include an interface 218, which may have a display 220 and audio device 222. The remote unit 72 may also be equipped with communication circuitry 224, such as wired communications circuitry 226, wireless communications circuitry 228, or both. The wireless communications circuitry 176 of the control system 27 and the wireless communications circuitry 228 of the remote unit 72 may include radio frequency (RF) circuitry, Bluetooth circuitry, wireless network circuitry, cellular communications circuitry, or any combination thereof.

The CMS 76 may include a processor 230 and a memory 232. The CMS 76 may control, monitor, and/or exchange data with the lift system 10 via a monitoring system 234 and a control system 236. The CMS 76 (e.g., server) may be located on-site or off-site relative to the lifting system 10. The CMS 76 includes a database 238, which contains data for various components affecting the lift positioning system 14. For example, the database 238 may include machine data 240, lift data 242, and CG data 244. In some embodiments, the data stored by the database 238 can include historical data, real time data, and so forth. The data may be utilized to compare system performance overtime to optimize the lift positioning system 14. The data may be sorted and accessed by various component identifiers, such as the serial number, model number, part number, and so forth. The CMS 76 also may include communication circuitry 246, such as wired communications circuitry 248, wireless communications circuitry 250, or both. The wireless communications circuitry 250 of the CMS 76 may include radio frequency (RF) circuitry, Bluetooth circuitry, wireless network circuitry, cellular communications circuitry, or any combination thereof.

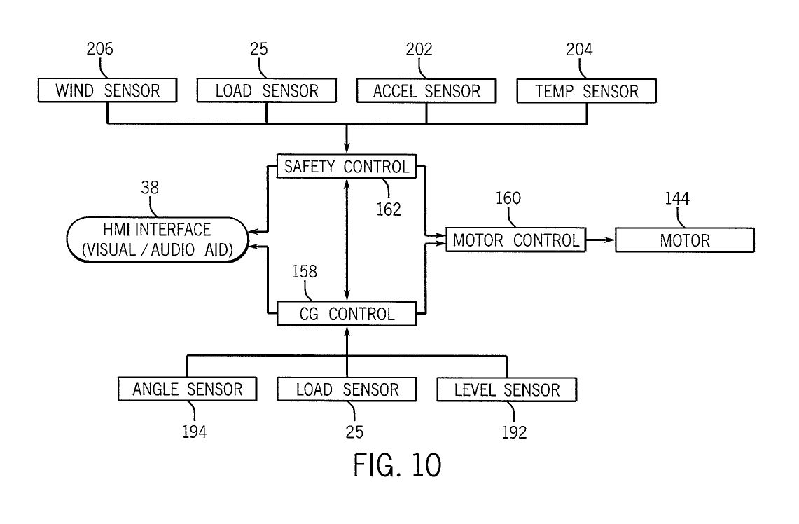

The control system 27 of the described embodiments may be further understood with respect to FIGS. 10-12. FIG. 10 is a schematic diagram of an embodiment of the control system 27 for controlling the lifting system 10 of FIGS. 1-3. As described above, the controller 28 may calculate appropriate positions of the center of gravity 13 (e.g., CG control 158) and other controls logic 156, such as the safety control 162. The controller 28 may utilize various sensor inputs (e.g., load sensor 25, acceleration sensor 202, temperature sensor 204, wind sensor 206, etc.) to calculate the safety controls logic 162. The controller 28 utilize various sensor inputs (e.g., load sensor 25, level sensor 192, angle sensor 194, etc.) to calculate the center of gravity control 158. Both the safety control logic 162 and center of gravity control 158 logic may affect the motor control 160 of the motor 144. The interface 38 (e.g., display 52 and audio device 56) may be configured to output visual and/or audio information relating the spreader bar 12, the load 15, the lift machine 11, and the platform 19, including information pertaining to the safety control 162 and the center of gravity control 158.

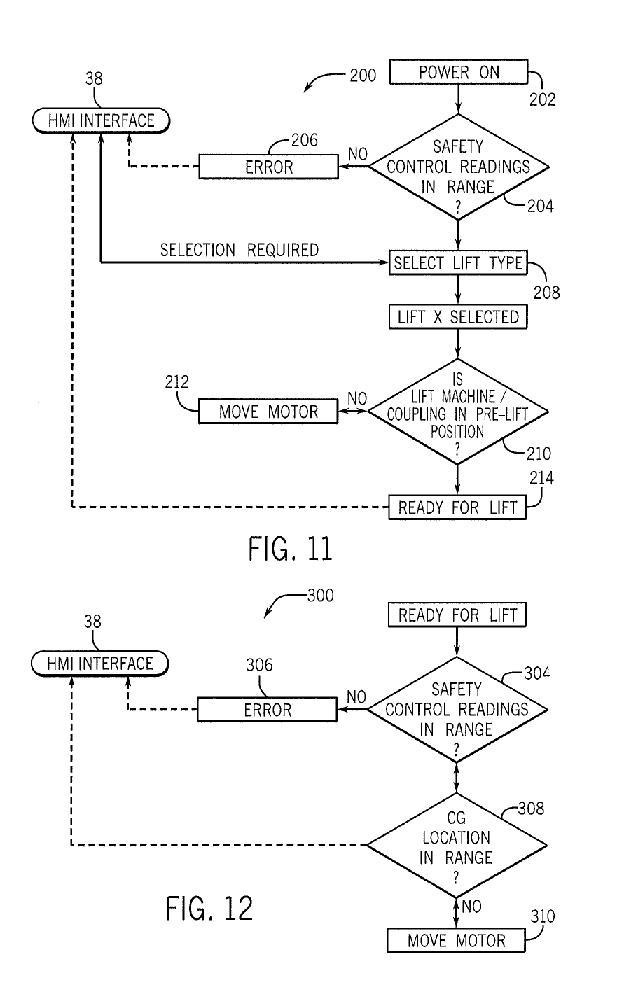

FIG. 11 is a flow chart of an embodiment of a computer-implemented method 200 for controlling start-up of the lifting system 10 of FIGS. 1-3. In a non-limiting example, the method 200 may include powering on the lifting system 10 (block 202) and determining if the safety control readings determined by the safety control logic 162 are within a specified range (block 204). If the safety control readings are not within the specified range, an error 206 is generated (block 206) and displayed on the interface 38. The method 200 may include selecting a lift type (block 208) via the interface 38. The method 200 may include determining if the lift machine 11, including lift coupling 16, is in pre-lifting position (block 210). If the lift machine 11 and lift coupling 16 is not in the proper position, the positioning is readjusted (block 212). The method 200 may include indicating via the interface 38 the lift machine 11 and lift coupling 16 are ready to lift when the proper position is reached (block 214).

FIG. 12 is a flow chart of an embodiment of a computer-implemented method 300 for controlling the operation of the lifting system 10 of FIGS. 1-3. In a non-limiting example, the method 300 may include determining if the safety control readings determined by the safety control logic 162 are within a specified range (block 304). If the safety control readings are not within the specified range, an error 306 is generated (block 306) and displayed on the interface 38. The method 300 may further include determining if a center of gravity location determined by the CG control 158 is within a specified range (block 308). If the center of gravity location is not within the specified range, the positioning is adjusted to be within the specified range of values (block 310). Information pertaining to the center of gravity location may also be displayed on the interface 38.

The technical effects of the disclosed embodiments enable the user to quickly determine the center of gravity of a load (e.g., heavy machinery) so that valuable time is saved when determining the center of gravity. A lift positioning system includes a spreader bar including a structural support, at least a first and a second load coupling, and a lift coupling that is coupled to a drive system (e.g., hydraulic, rack and pinion). The lift coupling is moved to the center of gravity (e.g., a range of acceptable limits within the center of gravity), thereby balancing the load for improved lifting operations. The center of gravity is visually identified to the user by a center of gravity (CG) indicator. The CG indicator may utilize lights or mechanical indicators to display the center of gravity, thereby further helping to balance the load. The CG indicator and the drive system are coupled to and controlled by a controller, which includes a processor and a memory. The controller may also be coupled to the drive system, a power source, a monitoring system, an interface, a spreader bar, and one or more sensors. The monitoring system monitors conditions affecting the lift system and includes a plurality of sensors. The sensors may include load sensors and a variety of other sensors such as proximity sensors, level sensors, angle sensors, tilt sensors, pitch sensors, roll sensors, accelerometers, wind sensors, temperature sensors, and vibration sensors, seismic sensors.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a spreader bar comprising a structural support, a first load coupling, and a second load coupling, and a lift coupling;
a drive system coupled to the lift coupling;
at least one load sensor configured to sense a load coupled to the first load coupling, the second load coupling, or a combination thereof;
a controller coupled to the drive system and the at least one load sensor, wherein the controller is configured to obtain data indicative of a center of gravity of the load based on the at least one load sensor, and the controller is configured to operate the drive system to move the lift coupling based on the center of gravity.

2. The system of claim 1, wherein the controller is configured to operate the drive system to move the lift coupling to a position within a threshold range about the center of gravity.

3. The system of claim 1, wherein the controller is coupled to the spreader bar.

4. The system of claim 1, comprising a display coupled to the at least one load sensor, the controller, or a combination thereof, wherein the display is configured to display data relating to lifting of the load with the spreader bar.

5. The system of claim 4, wherein the display is configured to display information relating to the load, a weight of the load, the center of gravity, or a combination thereof.

6. The system of claim 1, comprising an audio device coupled to the at least one load sensor, the controller, or a combination thereof, wherein the audio device is configured to output audio relating to lifting of the load with the spreader bar.

7. The system of claim 1, wherein the at least one load sensor comprises a first load sensor coupled to the first load coupling and a second load sensor coupled to the second load coupling.

8. The system of claim 7, wherein the spreader bar comprises a third load coupling, and the at least one load sensor comprises a third load sensor coupled to the third load coupling.

9. The system of claim 8, wherein the spreader bar comprises a fourth load coupling, and the at least one load sensor comprises a fourth load sensor coupled to the fourth load coupling.

10. The system of claim 1, wherein the at least one load sensor comprises a piezoelectric sensor, a strain gauge, a hydraulic pressure sensor, a pneumatic sensor, a fiber optic sensor, a vibrating wire sensor, a calibrated spring, or any combination thereof.

11. The system of claim 1, wherein the drive system comprises a drive coupled to the lift coupling with a transmission, and the drive is coupled to the controller.

12. The system of claim 11, wherein the transmission comprises a threaded shaft, a gear, a rack and pinion assembly, a worm and worm gear assembly, or a combination thereof.

13. The system of claim 11, wherein the drive comprises an electric motor, a hydraulic drive, a pneumatic drive, or a combination thereof.

14. The system of claim 11, wherein the drive comprises a manual actuator.

15. The system of claim 1, wherein the drive system comprises a plurality of drive systems.

16. The system of claim 1, comprising at least one center of gravity indicator configured to indicate the center of gravity.

17. The system of claim 16, wherein the at least one center of gravity indicator comprises a series of lights, an indicator configured to move along a series of visual indicia, or a combination thereof.

18. The system of claim 16, wherein the at least one center of gravity indicator comprises a first center of gravity indicator oriented in a first direction along the spreader bar and a second center of gravity indicator oriented in a second direction along the spreader bar, and the first and second directions are crosswise to one another.

19. The system of claim 1, comprising at least one sensor coupled to the controller, wherein the at least one sensor comprises a level sensor, an angle sensor, a tilt sensor, a pitch sensor, a roll sensor, an accelerometer, a temperature sensor, a wind sensor, a vibration sensor, a seismic sensor, or a combination thereof.

20. The system of claim 1, wherein the controller comprises a center of gravity control and a positioning control, and the controller comprises at least one of a safety control, an environmental control, an error handler control, a service control, a diagnostics control, a calibration control, or a combination thereof.

21. The system of claim 1, comprising a remote unit having a display and a controller, and a central control system having a database with lift data, center of gravity data, or a combination thereof.

22. A system, comprising:
a lift controller configured to couple to at least one load sensor and a drive system of a spreader bar, wherein the lift controller is configured to obtain data indicative of a center of gravity of a load coupled to the spreader bar based on load feedback from the at least one load sensor, and the lift controller is configured to operate the drive system to move a lift coupling based on the center of gravity.

23. The system of claim 22, comprising the at least one load sensor configured to sense a load coupled to a first load coupling, a second load coupling, or a combination thereof, of the spreader bar.

24. A method, comprising:
obtaining feedback from at least one load sensor indicative of a load coupled to at least one of a first load coupling or a second load coupling of a spreader bar, wherein the spreader bar comprises a structural support and a lift coupling;
obtaining data indicative of a center of gravity of the load based on the feedback from the at least one load sensor; and
controlling a drive system coupled to the lift coupling to move the lift coupling based on the center of gravity.

25. The system of claim 1, wherein the spreader bar is configured to lift a turbine engine.

26. The system of claim 1, wherein the at least one sensor comprises a pitch sensor and a roll sensor.

27. The system of claim 1, wherein the at least one sensor comprises an accelerometer.

28. The system of claim 1, comprising a powered base configured to rotate or move along a platform disposed on a ship.
